(19) United States
(12) Patent Application Publication
(10) Pub. No.: US 2012/0171583 A1
(43) Pub. Date: Jul. 5, 2012

(54) GAS PHASE ELECTROCHEMICAL REDUCTION OF CARBON DIOXIDE

(75) Inventors: Andrew B. Bocarsly, Plainsboro, NJ (US); Elizabeth Zeitler, Princeton, NJ (US); Andrew Mills, Forsyth, IL (US)

(73) Assignee: LIQUID LIGHT, INC., Monmouth Junction, NJ (US)

(21) Appl. No.: 13/340,155

(22) Filed: Dec. 29, 2011

Related U.S. Application Data
(60) Provisional application No. 61/428,524, filed on Dec. 30, 2010.

(51) Int. Cl. H01M 8/02; H01M 4/92; B82Y 30/00

(52) U.S. Cl. 429/413; 429/408; 977/773

(57) ABSTRACT

Methods and systems for gas phase electrochemical reduction of carbon dioxide are disclosed. A method for gas phase electrochemical reduction of carbon dioxide may include, but is not limited to, steps (A) to (C). Step (A) may include introducing a substantially gas phase fuel to an anode flow field of an anode of a proton exchange membrane (PEM) fuel cell. Said anode may be a gas diffusion electrode. Step (B) may include introducing a substantially gas phase carbon dioxide to a cathode flow field of a cathode of said PEM fuel cell. Said cathode may be a chemically modified gas diffusion electrode including a coating of a polymer aromatic amine. Step (C) may include reducing at least a portion of said substantially gas phase carbon dioxide to a product mixture at said cathode.

### CROSS-REFERENCE TO RELATED APPLICATIONS

Noon The present application claims the benefit under 35 U.S.C. §119(e) of U.S. patent application Ser. No. 61/428,524, filed Dec. 30, 2010.

The above-listed application is hereby incorporated by reference in its entirety.

### FIELD

The present disclosure generally relates to the field of electrochemical reactions, and more particularly to methods and/or systems for gas phase electrochemical reduction of carbon dioxide.

### BACKGROUND

The combustion of fossil fuels in activities such as electricity generation, transportation, and manufacturing produces billions of tons of carbon dioxide annually. Research since the 1970s indicates increasing concentrations of carbon dioxide in the atmosphere may be responsible for altering the Earth's climate, changing the pH of the ocean and other potentially damaging effects. Countries around the world, including the United States, are seeking ways to mitigate emissions of carbon dioxide.

A mechanism for mitigating emissions is to convert carbon dioxide into economically valuable materials such as fuels and industrial chemicals. If the carbon dioxide is converted using energy from renewable sources, both mitigation of carbon dioxide emissions and conversion of renewable energy into a chemical form that can be stored for later use will be possible.

However, the field of electrochemical techniques in carbon dioxide reduction has many limitations, including the stability of systems used in the process, the efficiency of systems, the selectivity of the systems or processes for a desired chemical, the cost of materials used in systems/processes, the ability to control the processes effectively, and the rate at which carbon dioxide is converted. In particular, existing electrochemical and photochemical processes/systems have one or more of the following problems that prevent commercialization on a large scale. Several processes utilize metals, such as ruthenium or gold, that are rare and expensive. In other processes, organic solvents were used that made scaling the process difficult because of the costs and availability of the solvents, such as dimethyl sulfoxide, acetonitrile, and propylene carbonate. Copper, silver and gold have been found to reduce carbon dioxide to various products, however, the electrodes are quickly “poisoned” by undesirable reactions on the electrode and often cease to work in less than an hour. Similarly, gallium-based semiconductors reduce carbon dioxide, but rapidly dissolve in water. Many cathodes produce a mixture of organic products. For instance, copper produces a mixture of gases and liquids including carbon monoxide, methane, formic acid, ethylene, and ethanol. Such mixtures of products make extraction and purification of the products costly and can result in undesirable waste products that must be disposed. Much of the work done to date on carbon dioxide reduction is inefficient because of high electrical potentials utilized, low faradaic yields of desired products, and/or high pressure operation. The energy consumed for reducing carbon dioxide thus becomes prohibitive. Many conventional carbon dioxide reduction techniques have very low rates of reaction. For example, in order to provide economic feasibility, a commercial system currently may require densities in excess of 100 milliamperes per centimeter squared (mA/cm²), while rates achieved in the laboratory are orders of magnitude less.

### SUMMARY

A method for gas phase electrochemical reduction of carbon dioxide may include, but is not limited to, steps (A) to (C). Step (A) may include introducing a substantially gas phase fuel to an anode flow field of an anode of a proton exchange membrane (PEM) fuel cell. Said anode may be a gas diffusion electrode. Step (B) may include introducing a substantially gas phase carbon dioxide to a cathode flow field of a cathode of said PEM fuel cell. Said cathode may be a chemically modified gas diffusion electrode including a coating of a polymer aromatic amine. Step (C) may include is reducing at least a portion of said substantially gas phase carbon dioxide to a product mixture at said cathode.

Another method for gas phase electrochemical reduction of carbon dioxide may include, but is not limited to, steps (A) to (E). Step (A) may include introducing a substantially gas phase fuel to an anode flow field of an anode of a proton exchange membrane (PEM) fuel cell. Said anode may be a first gas diffusion electrode. Step (B) may include coating a second gas diffusion electrode with a polymer aromatic amine to produce a coated gas diffusion electrode. Step (C) may include exposing said coated gas diffusion electrode to a solution containing sulfuric acid sufficient to protonate said polymer aromatic amine to produce a chemically modified gas diffusion electrode. Step (D) may include introducing a substantially gas phase carbon dioxide to a cathode flow field of said chemically modified gas diffusion electrode. Said chemically modified gas diffusion electrode may be a cathode of said PEM fuel cell. Step (E) may include reducing at least a portion of said substantially gas phase carbon dioxide to a product mixture at said cathode.

A system for electrochemical reduction of carbon dioxide may include, but is not limited to, a fuel cell. The fuel cell may include an anode including a gas diffusion electrode having an anode flow field, a cathode including a chemically modified gas diffusion electrode having a coating of a polymer aromatic amine, and a membrane electrode assembly positioned between said anode and said cathode. The system may also include a fuel source. Said fuel source may be coupled with said anode and may be configured to supply a gaseous fuel to said anode flow field. The system may further include a carbon dioxide input. Said carbon dioxide input may be coupled between a carbon dioxide source and said cathode and may be configured to supply gaseous carbon dioxide to said cathode flow field for reduction of said gaseous carbon dioxide to a product mixture at said cathode.

It is to be understood that both the foregoing general description and the following detailed description are exemplary and explanatory only and are not necessarily restrictive of the disclosure as claimed. The accompanying drawings, which are incorporated in and constitute a part of the specification, illustrate an embodiment of the disclosure and together with the general description, serve to explain the principles of the disclosure.

### BRIEF DESCRIPTION OF THE DRAWINGS

The numerous advantages of the present disclosure may be better understood by those skilled in the art by reference to the accompanying figures in which:

FIG. 1 is a block diagram of a system in accordance with an embodiment of the present disclosure;

FIG. 2 is a flow diagram of an example method of gas phase electrochemical reduction of carbon dioxide; and

FIG. 3 is a flow diagram of another example method of gas phase electrochemical reduction of carbon dioxide.

### DETAILED DESCRIPTION

Reference will now be made in detail to the presently preferred embodiments of the present disclosure, examples of which are illustrated in the accompanying drawings.

In accordance with some embodiments of the present disclosure, an electrochemical system is provided that generally allows electrochemical reduction of carbon dioxide substantially in the gas phase, thereby utilizing the greenhouse gas as a reactant to transfer the reaction energy into a chemical form that can be stored for later use. By facilitating the electrochemical reduction of carbon dioxide in the gas phase, improved reaction rates (e.g., as measured by current density of the electrochemical cell) may be achieved as compared to the reaction rate of a liquid-based electrochemical system. Additionally, some embodiments of the present disclosure provide for use of a heterogeneous catalyst, which may provide easier separation of products as compared to a homogeneous catalyst. Additionally, the use of a heterogeneous catalyst may improve the turnover number of the catalyst as compared to a homogeneous catalyst.

An electrochemical system of the present disclosure may selectively reduce carbon dioxide to a variety of organic products including, but not limited to, methanol and propanol. The industrial synthesis of many organic products using current techniques requires a large amount of energy, which generally comes from natural gas. The combustion of natural gas contributes to the concentration of carbon dioxide in the atmosphere and thus, global climate change. By utilizing carbon dioxide as a reactant, the present systems and methods may not negatively impact the concentration of carbon dioxide in the atmosphere and/or may reduce the amount of carbon dioxide present in the atmosphere.

Before any embodiments of the invention are explained in detail, it is to be understood that the embodiments may not be limited in application per the details of the structure or the function as set forth in the following descriptions or illustrated in the figures of the drawing. Different embodiments may be capable of being practiced or carried out in various ways. Also, it is to be understood that the phraseology and terminology used herein is for the purpose of description and should not be regarded as limiting. The use of terms such as “including,” “comprising,” or “having” and variations thereof herein are generally meant to encompass the item listed thereafter and equivalents thereof as well as additional items. Further, unless otherwise noted, technical terms may be used according to conventional usage.

Electrochemical reduction of carbon dioxide in the gas phase, tailored with certain electrocatalysts, may produce a variety of carbon-containing products, particularly when metal nanoparticle electrode materials are employed. The reduction of the carbon dioxide in the gas phase may be suitably achieved efficiently in an electrochemical cell based on a PEM (proton exchange membrane) type fuel cell configuration in which (i) humidified carbon dioxide is introduced to the cathode flow field, (ii) a fuel source (e.g., hydrogen (H₂)) is introduced to the anode flow field, and (iii) a MEA (membrane electrode assembly) is positioned between the anode and the cathode electrodes.

Advantageously, the carbon dioxide may be obtained from any source (e.g., an exhaust stream from fossil-fuel burning power or industrial plants, from geothermal or natural gas wells or the atmosphere itself). Most suitably, the carbon dioxide may be obtained from concentrated point sources of generation prior to being released into the atmosphere. For example, high concentration carbon dioxide sources may frequently accompany natural gas in amounts of 5% to 50%, exist in flue gases of fossil fuel (e.g., coal, natural gas, oil, etc.) burning power plants, and high purity carbon dioxide may be exhausted from cement factories, from fermenters used for industrial fermentation of ethanol, and from the manufacture of fertilizers and refined oil products. Certain geothermal steams may also contain significant amounts of carbon dioxide. The carbon dioxide emissions from varied industries, including geothermal wells, may be captured on-site. Separation of the carbon dioxide from such exhausts is known. Thus, the capture and use of existing atmospheric carbon dioxide in accordance with some embodiments of the present invention generally allow the carbon dioxide to be a renewable and unlimited source of carbon.

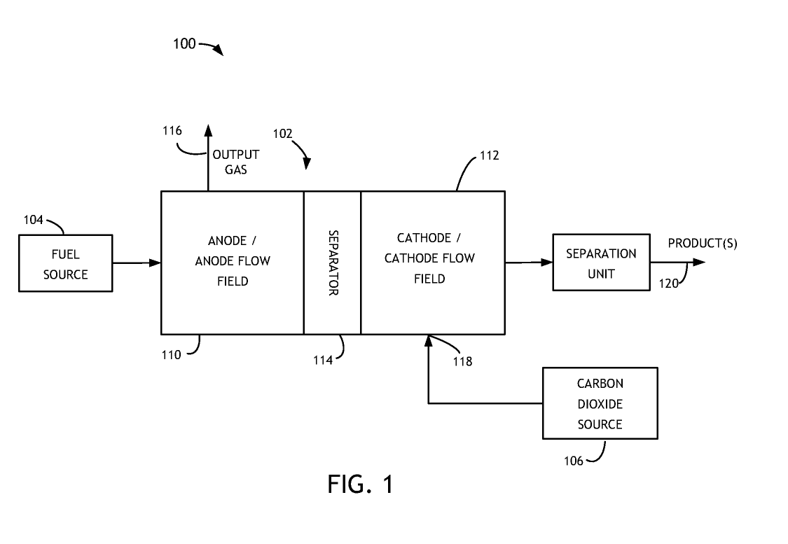

Referring to FIG. 1, a block diagram of a system 100 is shown in accordance with a specific embodiment of the present invention. System 100 may be utilized for gas phase electrochemical reduction of carbon dioxide to an organic product mixture. The system (or apparatus) 100 generally comprises a fuel cell 102, a fuel source 104, a carbon dioxide source 106, and a separation unit 108. A product or product mixture may be presented from the separation unit 108 for separation of the mixture into substantially individual compounds or components.

The fuel cell 102 may be implemented as a PEM (proton exchange membrane) fuel cell. The PEM fuel cell may be a 5 cm² PEM single cell fuel cell employing serpentine flow fields (e.g., a cathode flow field and a separate anode flow field). The fuel cell 102 is generally operational for gas phase electrochemical reduction of carbon dioxide to an organic product mixture including methanol, propanol, and the like. The reduction generally takes place by introducing humidified carbon dioxide into a cathode flow field and introducing hydrogen (H₂) into an anode flow field. A cathode 120 in the fuel cell 102 may reduce the carbon dioxide into the organic product mixture. In particular implementations, the system provided selectivity for methanol, with a 30% to 95% faradaic yield for carbon dioxide to methanol, with the remainder evolving hydrogen.

The fuel cell 102 generally comprises an anode 110, a cathode 112, and a separator (or membrane) 114 between the anode 110 and the cathode 112. The cathode 112 may generally comprise a carbon gas diffusion electrode coated with a polymerized heterocyclic catalyst, such as a pyridinium-containing polymer. In a particular implementation, the cathode 112 is a platinum nanoparticle on carbon gas diffusion electrode (such as an Etek LT-140 electrode) that may be coated with a thin layer of 4-polyvinylpyridine. The cathode 112 may then be treated with and/or exposed to a solution containing sulfuric acid (e.g., a dilute sulfuric acid solution) to protonate the interfacial pyridine for use in the reduction of carbon dioxide. The anode 110 may comprise a second, untreated carbon gas diffusion electrode (i.e., uncoated electrode) for reaction with the fuel from the fuel source 104 which may produce an output or waste gas 116 to be vented from the fuel cell 102, depending on the fuel utilized. While the cathode 112 is described above as including a platinum nanoparticle on carbon gas diffusion electrode with an applied layer of 4-polyvinylpyridine, other electrodes may be utilized. For instance, metal nanoparticle electrode catalysts may include palladium, or first row transition metal catalysts. Additionally, other polymer aromatic amine electrocatalysts may be utilized at the surface of the cathode 112 in place of the polyvinylpyridinium.

The separator (or membrane) 114 may include a membrane electrode assembly (MEA) positioned between the anode 110 and the cathode 112. In a particular implementation, the separator (or membrane) 114 is formed by thermally sealing an ion-exchange membrane (e.g., a Nafion 117 membrane, or other suitable membrane) between the electrodes of the anode 110 and the cathode 112. The fuel cell 102 may be controlled by a potentiostat (e.g., CHI-1140, PAR 273A, or other suitable potentiostat) used in a two electrode configuration.

The fuel source 104 may implement a hydrogen source. The fuel source 104 may alternatively implement the oxidation of water to oxygen at the anode 110 in place of hydrogen. In a particular implementation, humidified hydrogen at approximately 90° C. is introduced into the anode flow field. The carbon dioxide source 106 may implement a carbon dioxide source to provide carbon dioxide to the fuel cell 102. For instance, the fuel cell 102 may include a carbon dioxide input 118, such as a port configured to be coupled between the carbon dioxide source 106 and the cathode 112. In some embodiments, the carbon dioxide is introduced through the carbon dioxide input 118 into the cathode flow field of the cathode 112. In a particular implementation, humidified carbon dioxide at approximately 90° C. is introduced into the cathode flow field. Additionally, an implementation of the present disclosure may utilize an electrolyzer for reducing carbon dioxide and water in the gas phase.

The separator 108 may implement an organic product and/or inorganic product extractor. The separator 108 is generally operational to extract (separate) one or products of the product mixture (e.g., methanol, propanol, and the like) from other components of the product mixture. Additionally, the separator may be operational to separate any waste gases from the product stream. The extracted products may be presented through a port 120 of the system 100 for subsequent storage and/or consumption by other devices and/or processes.

As described herein, the present disclosure may be implemented via a fuel cell system for gas phase electrochemical reduction of carbon dioxide to an organic product mixture utilizing a chemically modified gas diffusion electrode coated with a pyridinium-containing polymer as an electrocatalyst for the carbon dioxide reduction. The system may provide selectivity of methanol as part of the organic product mixture, with a 30% to 95% faradaic yield for carbon dioxide to methanol, with the remainder evolving hydrogen. As described above, the use of gas phase reactants improves the rate of reaction, as measured by current density, as compared to liquid phase electrochemical reactions. In addition, polymerized heterocyclic catalysts are heterogeneous, which makes product separation easier as compared to when the pyridinium or other catalyst is homogenous. Heterogeneous catalysts also include an improved turnover number as compared to homogeneous catalysts.

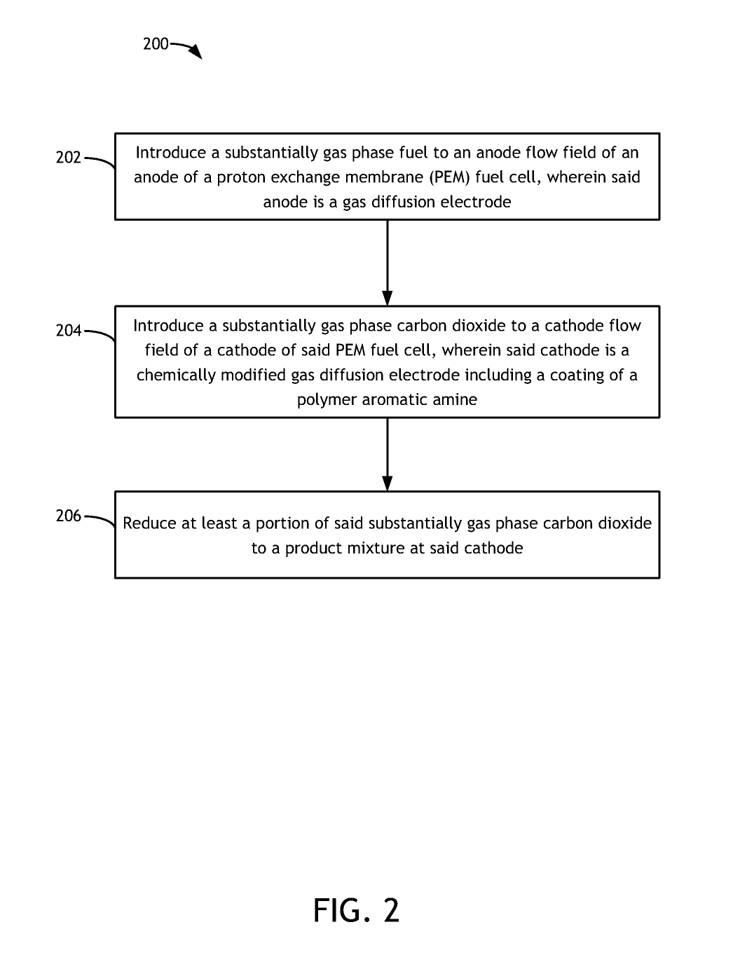

Referring to FIG. 2, a flow diagram of an example method 200 for gas phase electrochemical reduction of carbon dioxide is shown. The method (or process) 200 generally comprises a step (or block) 202, a step (or block) 204, and a step (or block) 206. The method 200 may be implemented using the system 100 and the steps may be performed in an order other than that indicated below, including concurrently.

In the step 202, a substantially gas phase fuel may be introduced to an anode flow field of an anode of a proton exchange membrane (PEM) fuel cell. The anode may be a gas diffusion electrode. Introducing a substantially gas phase carbon dioxide to a cathode flow field of a cathode of said PEM fuel cell may be performed in the step 204. The cathode may be a chemically modified gas diffusion electrode including a coating of a polymer aromatic amine. In the step 206, at least a portion of said substantially gas phase carbon dioxide may be reduced to a product mixture at said cathode.

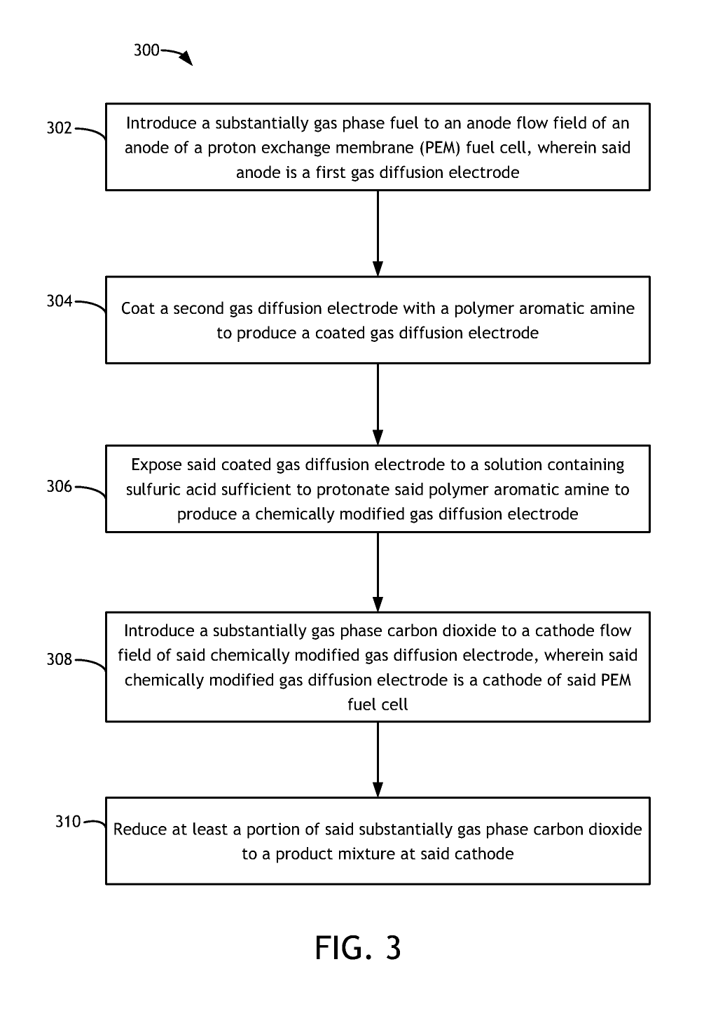

Referring to FIG. 3, a flow diagram of an example method 300 for gas phase electrochemical reduction of carbon dioxide is shown. The method (or process) 300 generally comprises a step (or block) 302, a step (or block) 304, a step (or block) 306, a step (or block) 308, and a step (or block) 310. At least a portion of the method 300 may be implemented using the system 100 and the steps may be performed in an order other than that indicated below, including concurrently.

In the step 302, a substantially gas phase fuel may be introduced to an anode flow field of an anode of a proton exchange membrane (PEM) fuel cell. The anode may be a first gas diffusion electrode. Coating a second gas diffusion electrode with a polymer aromatic amine to produce a coated gas diffusion electrode may be performed in the step 304. In the step 406, the coated gas diffusion electrode may be exposed to a solution containing sulfuric acid sufficient to protonate said polymer aromatic amine to produce a chemically modified gas diffusion electrode. Introducing a substantially gas phase carbon dioxide to the chemically modified gas diffusion electrode may be performed in the step 408. The chemically modified gas diffusion electrode may be a cathode of the PEM fuel cell. In the step 410, at least a portion of said substantially gas phase carbon dioxide to a product mixture at said cathode.

It is believed that the present disclosure and many of its attendant advantages will be understood by the foregoing description, and it will be apparent that various changes may be made in the form, construction and arrangement of the components thereof without departing from the scope and spirit of the disclosure or without sacrificing all of its material advantages. The form herein before described being merely an explanatory embodiment thereof, it is the intention of the following claims to encompass and include such changes.

What is claimed is:

1. A method for gas phase electrochemical reduction of carbon dioxide, comprising:
(A) introducing a substantially gas phase fuel to an anode flow field of an anode of a proton exchange membrane (PEM) fuel cell, wherein said anode is a gas diffusion electrode;
(B) introducing a substantially gas phase carbon dioxide to a cathode flow field of a cathode of said PEM fuel cell, wherein said cathode is a chemically modified gas diffusion electrode including a coating of a polymer aromatic amine; and
(C) reducing at least a portion of said substantially gas phase carbon dioxide to a product mixture at said cathode.

2. The method of claim 1, where said coating of said polymer aromatic amine comprises a coating of a pyridinium-containing polymer.

3. The method of claim 2, wherein said coating of a pyridinium-containing polymer comprises a coating of 4-polyvinylpyridine.

4. The method of claim 1, wherein introducing a substantially gas phase fuel to an anode flow field of an anode of a proton exchange membrane (PEM) fuel cell comprises:
introducing a humidified hydrogen stream to said anode flow field of said anode of said PEM fuel cell.

5. The method of claim 1, wherein introducing a substantially gas phase carbon dioxide to a cathode flow field of a cathode of said PEM fuel cell comprises:
introducing a humidified carbon dioxide stream to said cathode flow field of said cathode of said PEM fuel cell.

6. The method of claim 1, wherein at least one of said gas diffusion electrode of said anode or said chemically modified gas diffusion electrode of said cathode includes a metal nanoparticle on carbon gas diffusion electrode.

7. The method of claim 6, wherein said metal nanoparticle on carbon gas diffusion electrode is a platinum nanoparticle on carbon gas diffusion electrode.

8. The method of claim 1, wherein said product mixture includes at least one of methanol or propanol.

9. The method of claim 7, wherein said PEM fuel cell provides between approximately 30% to 95% faradaic yield for methanol.

10. The method of claim 1, further including:
thermally sealing an ion-exchange membrane between said anode and said cathode of said PEM fuel cell.

11. A method for gas phase electrochemical reduction of carbon dioxide, comprising:
(A) introducing a substantially gas phase fuel to an anode flow field of an anode of a proton exchange membrane (PEM) fuel cell, wherein said anode is a first gas diffusion electrode;
(B) coating a second gas diffusion electrode with a polymer aromatic amine to produce a coated gas diffusion electrode;
(C) exposing said coated gas diffusion electrode to a solution containing sulfuric acid sufficient to protonate said polymer aromatic amine to produce a chemically modified gas diffusion electrode;
(D) introducing a substantially gas phase carbon dioxide to a cathode flow field of said chemically modified gas diffusion electrode, wherein said chemically modified gas diffusion electrode is a cathode of said PEM fuel cell; and
(E) reducing at least a portion of said substantially gas phase carbon dioxide to a product mixture at said cathode.

12. The method of claim 11, wherein coating a second gas diffusion electrode with a polymer aromatic amine to produce a coated gas diffusion electrode comprises:
coating said second gas diffusion electrode with a pyridinium-containing polymer to produce said coated gas diffusion electrode.

13. The method of claim 12, wherein coating said second gas diffusion electrode with a pyridinium-containing polymer to produce said coated gas diffusion electrode comprises:
coating said second gas diffusion electrode with 4-polyvinylpyridine to produce said coated gas diffusion electrode.

14. The method of claim 11, wherein introducing a substantially gas phase fuel to an anode flow field of an anode of a proton exchange membrane (PEM) fuel cell comprises:
introducing a humidified hydrogen stream to said anode flow field of said anode of said PEM fuel cell.

15. The method of claim 11, wherein introducing a substantially gas phase carbon dioxide to a cathode flow field of said chemically modified gas diffusion electrode comprises:
introducing a humidified carbon dioxide stream to said cathode flow field of said cathode of said PEM fuel cell.

16. The method of claim 11, wherein at least one of said gas diffusion electrode or said chemically modified gas diffusion electrode includes a metal nanoparticle on carbon gas diffusion electrode.

17. The method of claim 16, wherein said metal nanoparticle on carbon gas diffusion electrode is a platinum nanoparticle on carbon gas diffusion electrode.

18. The method of claim 11, wherein said product mixture includes at least one of methanol or propanol.

19. A system for gas phase electrochemical reduction of carbon dioxide, comprising:
a fuel cell, including:
an anode including a gas diffusion electrode having an anode flow field;
a cathode including a chemically modified gas diffusion electrode having a coating of a polymer aromatic amine; and
a membrane electrode assembly positioned between said anode and said cathode;
a fuel source, said fuel source coupled with said anode, said fuel source configured to supply a gaseous fuel to said anode flow field; and
a carbon dioxide input, said carbon dioxide input configured to be coupled between a carbon dioxide source and said cathode, said carbon dioxide input configured to provide gaseous carbon dioxide to said cathode flow field for reduction of said gaseous carbon dioxide to a product mixture at said cathode.

20. The system of claim 19, wherein said polymer aromatic amine includes 4-polyvinylpyridine.

21. The system of claim 19, wherein said gaseous fuel includes humidified hydrogen.

22. The system of claim 19, wherein said fuel cell is configured to provide between approximately 30% to 95% faradaic yield for methanol.
